(19) United States
(12) Patent Application Publication
(10) Pub. No.: US 2026/0118853 A1
(43) Pub. Date: Apr. 30, 2026

(54) NUMERICAL CONTROL DEVICE

(71) Applicant: Mitsubishi Electric Corporation, Tokyo (JP)

(72) Inventor: Keishi NAGAE, Tokyo (JP)

(73) Assignee: Mitsubishi Electric Corporation, Tokyo (JP)

(21) Appl. No.: 19/143,407

(22) PCT Filed: Feb. 20, 2023
(86) PCT No.: PCT/JP2023/006024

§ 371 Date: Jun. 26, 2025

(51) Int. Cl. G05B 19/416

(52) U.S. Cl. CPC G05B 19/4163; G05B 2219/50325

(57) ABSTRACT

A numerical control device includes a rotation command output unit that outputs a rotation command to relatively rotate a workpiece and a tool, and a feed command output unit that outputs a feed command to relatively move the workpiece and the tool. The feed command can include a vibration motion command to alternately repeat a forward motion and a backward motion. The vibration motion command includes, in one vibration, a first section for travel at a first speed that is a travel speed during the forward motion, a second section for travel at a second speed that is a travel speed during the backward motion, and a third section for travel at a third speed that is a travel speed during the forward motion and is a speed lower than the first speed.

### FIELD

The present disclosure relates to a numerical control device that is a control device for a machine tool.

### BACKGROUND

A known cutting has a function of a vibration cutting that allows a cutting tool and a workpiece to relatively vibrate in a machining direction, thereby finely breaking chips (for example, Patent Literature 1).

During machining using the vibration cutting function, a forward motion in the same direction as the machining direction and a backward motion in the direction opposite to the machining direction are alternately repeated during the cutting. The relative travel speed between the cutting tool and the workpiece during the forward motion is higher than the relative travel speed during non-vibration machining that is normal machining without vibration cutting. This is why the average relative travel speed, which is the sum of the forward motion and the backward motion, can be equal to the relative travel speed during non-vibration machining although the vibration cutting involves the backward motion. This allows vibration cutting to be applied without changing machining time, that is, productivity.

### CITATION LIST

### Patent Literature

Patent Literature 1: Japanese Patent No. 7096227

### SUMMARY OF INVENTION

### Problem to be Solved by the Invention

The use of the vibration cutting function in Patent Literature 1 provides a higher relative travel speed during the forward motion than non-vibration machining, which results in a temporary increase in the load between the tool and the workpiece. In this case, the tool wear can accelerate, the tool can break down, etc. because of excessive cutting force and cutting heat. In addition, it is not possible to satisfy machining conditions for a feed rate, which indicates the relative travel speed between the tool and the workpiece, a spindle rotational speed, which indicates the relative rotational speed between the tool and the workpiece, and a cut thickness, etc. This results in a problem of, for example, the degradation of the machined surface quality that indicates the smoothness of a machined surface.

The present disclosure has been made in view of the above. It is an object of the present disclosure to provide a numerical control device capable of reducing machining problems caused by an increase in the relative travel speed between a tool and a workpiece in vibration cutting.

### Means to Solve the Problem

To solve the above problem and achieve the object, a numerical control device according to the present disclosure comprises: a rotation command output unit to output a rotation command to relatively rotate a workpiece and a tool; and a feed command output unit to output a feed command to relatively move the workpiece and the tool, the feed command being able to include a vibration motion command to alternately repeat a forward motion and a backward motion. The vibration motion command includes, in one vibration, a first section for travel at a first speed that is a travel speed during the forward motion, a second section for travel at a second speed that is a travel speed during the backward motion, and a third section for travel at a third speed that is a travel speed during the forward motion and is a speed lower than the first speed.

### Effects of the Invention

The numerical control device of the present disclosure has an advantage of reducing the machining problems caused by the increase in the relative travel speed between the tool and the workpiece in vibration cutting.

### BRIEF DESCRIPTION OF DRAWINGS

FIG. 1 is a block diagram illustrating an exemplary configuration of a numerical control device according to a first embodiment.

FIG. 2 is an explanatory diagram of a method of determining the end point of a backward motion in the numerical control device of the first embodiment.

FIG. 3 is an explanatory diagram of a method of determining the waveform of a forward motion in the numerical control device of the first embodiment.

FIG. 4 is an explanatory diagram of a method of determining a basic vibration waveform.

FIG. 5 is an explanatory diagram of a method of determining a vibration waveform with a third section in the numerical control device of the first embodiment.

FIG. 6 is an explanatory diagram of a method of determining another basic vibration waveform without the third section in the numerical control device of the first embodiment.

FIG. 7 is an explanatory diagram of a method of determining another vibration waveform with the third section in the numerical control device of the first embodiment.

FIG. 8 is an explanatory diagram of a method of determining another vibration waveform with the third section in the numerical control device of the first embodiment.

FIG. 9 is an explanatory diagram of another method of determining a vibration waveform with the third section in the numerical control device of the first embodiment.

FIG. 10 is an explanatory diagram of another method of determining a vibration waveform with the third section in the numerical control device of the first embodiment.

FIG. 11 is an explanatory diagram of another method of determining a vibration waveform with the third section in the numerical control device of the first embodiment.

FIG. 12 is an explanatory diagram of another method of determining a vibration waveform with the third section in the numerical control device of the first embodiment.

FIG. 13 is an explanatory diagram of another method of determining a vibration waveform with the third section in the numerical control device of the first embodiment.

FIG. 14 is a diagram illustrating an example of a data table used to create the vibration waveform with the third section in the numerical control device of the first embodiment.

FIG. 15 is a diagram illustrating another example of a data table used to create the vibration waveform with the third section in the numerical control device of the first embodiment.

FIG. 16 is a block diagram illustrating a learning-time configuration of a numerical control device according to a third embodiment.

FIG. 17 is a diagram illustrating an exemplary configuration of a neural network used in the numerical control device of the third embodiment.

FIG. 18 is a flowchart of a learning process in the numerical control device of the third embodiment.

FIG. 19 is a block diagram illustrating a reference-time configuration of the numerical control device according to the third embodiment.

FIG. 20 is a flowchart of an inference process in the numerical control device of the third embodiment.

FIG. 21 is a diagram illustrating an exemplary hardware configuration of the numerical control device of the first to third embodiments.

### DESCRIPTION OF EMBODIMENTS

A numerical control device according to embodiments will be hereinafter described in detail with reference to the drawings.

### First Embodiment

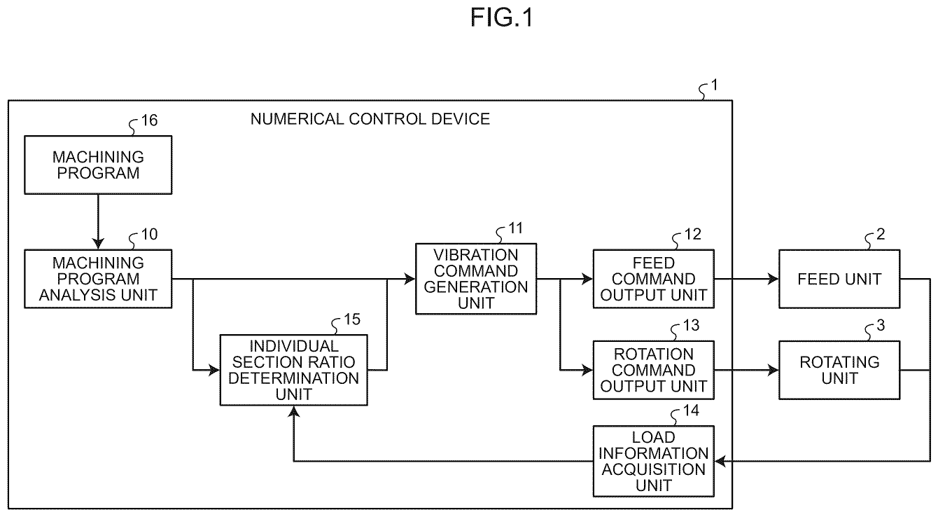

FIG. 1 is a block diagram illustrating an exemplary configuration of a numerical control device according to a first embodiment. A numerical control device 1 in the present embodiment includes a machining program analysis unit 10, an individual section ratio determination unit 15, a vibration command generation unit 11, a feed command output unit 12, a rotation command output unit 13, and a load information acquisition unit 14.

The machining program analysis unit 10 analyzes a machining program 16 and outputs motion command information described in the machining program 16 to the individual section ratio determination unit 15 and the vibration command generation unit 11.

The machining program 16 may be in any format, and may be, for example, character strings in Electronic Industries Alliance (EIA)/International Organization for Standardization (ISO) format, or may be a program of a configuration including information such as the shape, machined shape, and dimensions of a workpiece, called an interactive program.

The motion command information includes the coordinate values of a starting point and an end point defining a relative travel path between a tool and a workpiece, a method of interpolating the travel path connecting the starting point and the end point (such as linear interpolation or circular interpolation), a feed rate during travel, the number of revolutions of a spindle, a rotation direction, and the like. Furthermore, the motion command information may include information on whether or not vibration cutting is enabled, and information specifying the shape of a vibration waveform.

The information specifying the shape of the vibration waveform is information on the vibration frequency, the vibration amplitude, the number of vibrations per unit time or the number of vibrations per unit count, and the ratios of sections to be described below, for example. Note that all of these pieces of information specifying the shape of the vibration waveform do not necessarily need to be specified, and some of them may be omitted.

The individual section ratio determination unit 15 determines the ratios of a first section, a second section, and a third section in one vibration. This ratio will be hereinafter referred to as individual section ratios, the ratio of each section, etc. where necessary.

One vibration is a unit of vibration superimposed on a normal machining travel motion in vibration cutting. For example, when the number of vibrations N is 1.0, the spindle rotation angle per vibration is 360 degrees. The individual section ratio determination unit 15 outputs the determined ratios to the vibration command generation unit 11. A method of determining the individual section ratios may include determining the section ratios on the basis of the information from the machining program analysis unit 10 or determining the section ratios on the basis of vales in external information such as preset parameters by reference to the external information.

The vibration command generation unit 11 calculates the vibration waveform on the basis of the information from the machining program analysis unit 10, and creates a feed command for a feed axis and a rotation command for the spindle. A method of calculating the vibration waveform will be described below. The ratio of each section in a vibration motion may use information input from the individual section ratio determination unit 15, or the ratio of each section in a vibration motion may be determined on the basis of values in information such as preset parameters by reference to the information.

The feed command output unit 12 outputs the feed command generated by the vibration command generation unit 11, to a feed unit 2 of a control target, i.e., a machine tool. The feed unit 2, which can be a servomotor and a Servo amplifier that controls the servo motor, is any means that enables relative travel between the workpiece and the tool and a vibration motion as well.

The rotation command output unit 13 outputs the rotation command generated by the vibration command generation unit 11 to a rotating unit 3 included in the machine tool to be controlled. The rotating unit 3, which can be a spindle motor and a spindle amplifier that controls the spindle motor, is any means that enables relative rotation between the workpiece and the tool.

Machining by vibration cutting is enabled by the feed unit 2 and the rotating unit 3 moving and rotating the workpiece and the tool relative to each other, in accordance with the feed command and the rotation command generated by the vibration command generation unit 11. Contact between the workpiece and the tool relatively rotating cuts the workpiece, and relative travel therebetween enables machining the workpiece into a desired shape. This travel involves vibration, so that forward and backward motions cause air cutting, that is, discontinuation of cutting, thereby exhibiting the vibration cutting effect of finely breaking chips.

A method of calculating the vibration waveform will be described. First, the method will be described taking an example where the number of vibrations N per spindle revolution is 0.5, that is, an example of one vibration for every two spindle revolutions.

The relative travel speed between the workpiece and the tool is hereinafter referred to as a feed rate. The unit of the feed rate may be represented by the amount of travel per unit time, for example, mm/min, or may be represented by the amount of travel per spindle revolution, for example, mm/rev. Although the unit of feed rate can be represented by either of the amount of travel per unit time and the amount of travel per spindle revolution, the description will be made representing the unit of feed rate by the amount of travel per spindle revolution for the purpose of facilitation of understanding of the present embodiment.

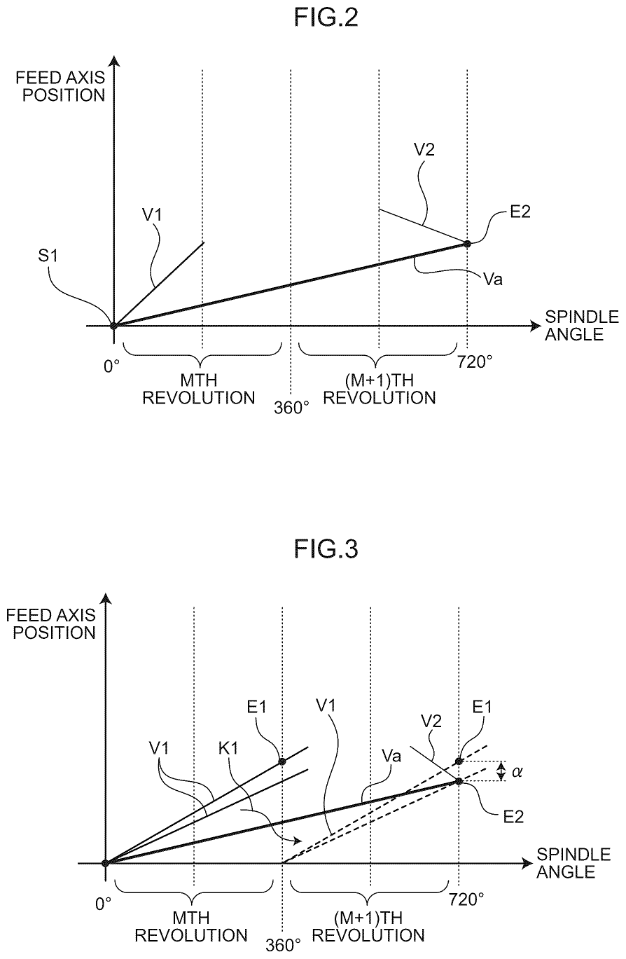

First, a method of determining the end point of a backward motion waveform will be described with reference to FIG. 2. FIG. 2 is an explanatory diagram of a method of determining the end point of a backward motion in the numerical control device of the first embodiment. In FIG. 2, the vertical axis represents the feed axis position, and the horizontal axis represents the spindle angle. Va represents the feed axis travel speed (travel waveform) during non-vibration machining, which is normal machining without vibration cutting. V1 represents the travel speed (travel waveform) of a forward motion during vibration machining. V2 represents the travel speed (travel waveform) of the backward motion during vibration machining. Since the number of vibrations N per spindle revolution is 0.5 in the present description, a waveform in the Mth spindle revolution and a waveform in the (M+1) th spindle revolution, which are waveforms in two spindle revolutions, are illustrated in FIG. 2. FIG. 2 is provided assuming that the initial angle when the spindle makes the Mth revolution is zero degrees.

If the feed axis having completed one vibration motion returns to the same position as the feed axis travelling at the feed axis travel speed Va during non-vibration machining, the average feed rate is common to an effective vibration cutting and an ineffective vibration cutting, so that machining can be performed without changing machining time. Thus, the end point E2 of the travel waveform V2 of the backward motion is set on a straight line indicating the feed axis travel speed Va during non-vibration machining. Since the number of vibrations N per spindle revolution is 0.5, the end point E2 of the travel waveform V2 of the backward motion is at the position of time the spindle rotates 720 degrees from the starting point S1 of the travel waveform V1 of the forward motion. In this manner, the end point E2 of the travel waveform V2 of the backward motion is determined.

Next, a method of determining the travel waveform V1 of the forward motion will be described with reference to FIG. 3. FIG. 3 is an explanatory diagram of a method of determining the waveform of the forward motion in the numerical control device of the first embodiment. In FIG. 3, the vertical axis represents the feed axis position, and the horizontal axis represents the spindle angle. Va represents the feed axis travel speed during non-vibration machining. Vi represents the travel speed of the forward motion during vibration machining. V2 represents the travel speed of the backward motion during vibration machining. With the travel waveform V1 of the forward motion in the Mth spindle revolution shifted to the (M+1) th spindle revolution, as indicated by an arrow K1 in FIG. 3, consider how a portion forming the travel waveform V1 of the forward motion in the Mth spindle revolution is related to the travel waveform V2 of the backward motion in the (M+1) th spindle revolution. If the travel waveform V2 of the backward motion and the travel waveform V1 of the forward motion in the Mth spindle revolution indicated by a broken line intersect, it is thought that an air-cutting motion theoretically occurring in an area including the intersection breaks a chip.

In practice, however, the tool cutting edge can have its amplitude smaller than a command amplitude, and hence fail to break chips. This is presumably caused under the influence of, for example, such a mechanical structure located between the motor and the tool cutting edge as a drive feed mechanism such as a ball screw and a tool rest. In practice, thus, it is desirable to adjust the vibration waveform by making the end point E1 of the forward motion greater than the end point E2 of the backward motion so as to produce a certain margin & for an air-cutting zone.

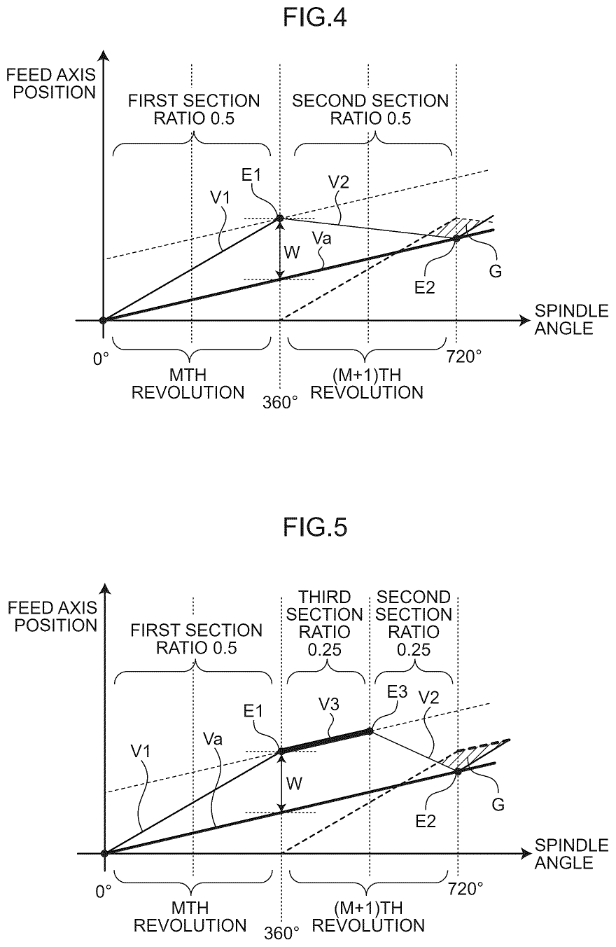

This technique determines the slope of the travel waveform V1 of the forward motion in the Mth spindle revolution, that is, a first speed that is the travel speed V1 of the forward motion. FIG. 4 is an explanatory diagram of a method of determining a basic vibration waveform. As illustrated in FIG. 4, when the ratio between the first section that is a section of the forward motion and the second section that is a section of the backward motion is, for example, 0.5:0.5, the end point E1 of the forward motion is determined. With this end point E1 as a starting point, the slope of the travel waveform V2 of the backward motion is also determined, and a second speed that is the travel speed V2 of the backward motion is determined. Thus, a basic vibration waveform including the forward motion in the first section and the backward motion in the second section but not including the third section is calculated, and the vibration amplitude W is also determined. The vibration amplitude W is expressed, for example, as the distance between the end point E1 of the forward motion and the position during non-vibration machining corresponding to the end point E1.

The above is the method of calculating the basic vibration waveform. Note that the calculation of the vibration waveform is not limited to this method. For example, another possible method is to calculate the vibration waveform from the vibration frequency, determine the presence or absence and the size of an air-cutting zone, and adjust the amplitude. In FIG. 4, an area indicated by hatching is an air-cutting zone G.

In the first embodiment, for example, the third section for forward travel at a third speed V3 that is a speed lower than the first speed is provided between the first section, which is the forward motion section for travel at the first speed V1, and the second section, which is the backward motion section for travel at the second speed V2. The following describes a method of calculating the vibration waveform with the third section for travel at the third speed V3. The description is made taking an example where the ratio of the first section is not changed, the second section is halved, a half of the second section is set as the second section, and the remaining half of the second section is set as the third section.

Calculation up to the determination of the end point E1 of the forward motion is the same as that described with FIGS. 2 and 3. FIG. 5 is an explanatory diagram of a method of determining the vibration waveform with the third section in the numerical control device of the first embodiment. In FIG. 5, the third speed V3 is the same as the feed axis travel speed Va during non-vibration machining. When the third speed V3 is determined, the end point E3 of a waveform at the third speed V3 is calculated in accordance with the ratio of the third section. With the end point E3 as a starting point and the end point E2 of the backward motion as an end point, the waveform of the backward motion is calculated to thereby determine the second speed V2. In the above manner, the vibration waveform having the section at the third speed V3 can be calculated without changing the vibration amplitude W.

Although the third speed V3 in the example of FIG. 5 is the same as the feed axis travel speed Va during non-vibration machining, but the third speed V3 may be any other speed lower than the first speed V1.

A supplementary explanation is given of the relationship between the top dead center and the bottom dead center, of the vibration waveform and the waveform of the feed axis position during non-vibration machining. The waveform of the feed axis position during non-vibration machining indicates the feed axis position required to obtain a desired shape that should be formed by machining. That is, if the cutting tool advances to the workpiece beyond the waveform of the feed axis position during non-vibration machining, the cutting tool cuts the workpiece more than necessary to obtain a desired shape. If this is not the case, the cutting of the workpiece is insufficient leaving a portion thereof that needs cutting. Such a uncut portion can be cut by additional machining to thereby provide the desired shape. However, the workpiece that is once cut too much cannot be restored by normal cutting. Thus, too much cutting needs to be avoided.

In the present embodiment, the top dead center or the bottom dead center, of the vibration matches the waveform of the feed axis position during non-vibration machining, such that vibration cutting is performed on the workpiece without cutting the workpiece too much.

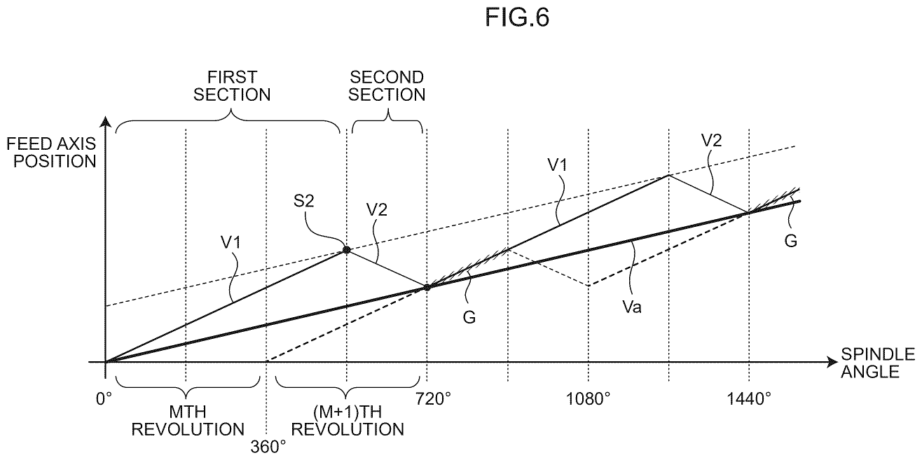

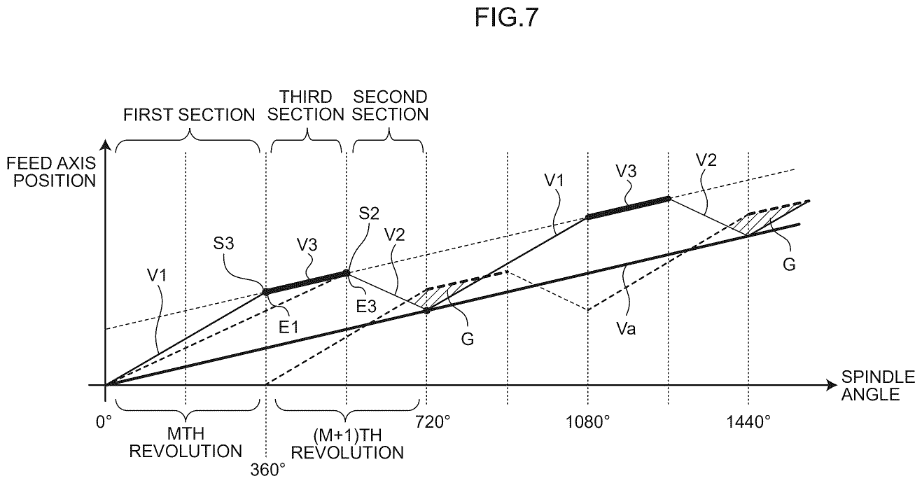

FIG. 6 is an explanatory diagram of a method of determining another basic vibration waveform without the third section in the numerical control device of the first embodiment. In FIG. 6, the ratio of the first section is three times the ratio of the second section. FIG. 7 is an explanatory diagram of a method of determining another vibration waveform with the third section in the numerical control device of the first embodiment. In FIG. 7, the third section is added to the vibration waveform in FIG. 6 such that the first section: the second section: the third section=0.5:0.25:0.25. In the vibration waveform of FIG. 6, the travel waveform of the previous forward motion and the travel waveform of the current backward motion intersect at positions at 720 degrees and 1440 degrees for the purpose of facilitating the understanding the difference from FIG. 7.

In the case where the ratio of the first section is reduced from 0.75 to 0.5 and the third section is added, as illustrated in FIGS. 6 and 7, the starting point S3 of the third section is calculated with the starting point S2 of the second section as the end point E3 of the third section unlike the above-described example. By setting the starting point S3 of the third section as the end point E1 of the first section, the first speed is determined. In FIG. 7, the third speed V3 is the same as the feed axis travel speed Va during non-vibration machining.

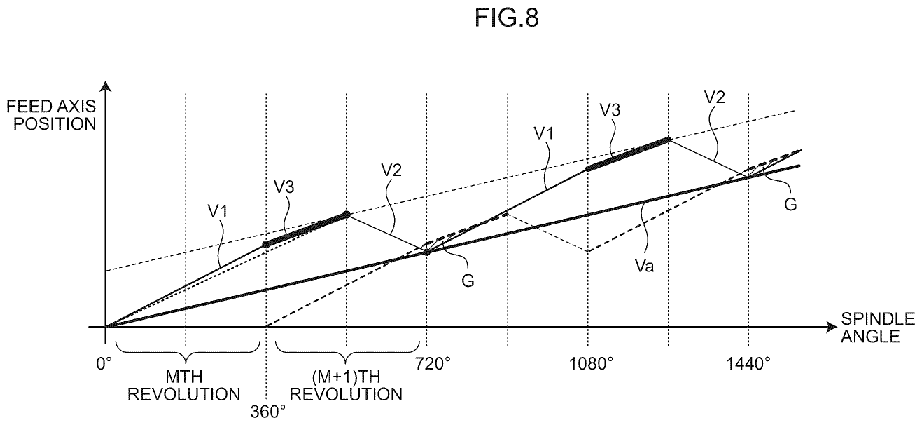

FIG. 8 is an explanatory diagram of a method of determining another vibration waveform with the third section in the numerical control device of the first embodiment. In FIG. 8, the third speed V3 is a speed lower than the first speed V1 and different from the feed axis travel speed Va during non-vibration machining. In the case of FIG. 8, the end point position of the first section changes.

Although the above description has been made assuming that the number of vibrations N per spindle revolution is 0.5, the present embodiment can be applied regardless of the value of the number of vibrations N. Although descriptions have been given of the calculation methods with a procedure that adds adding the third section with the first section and the second section determined, the vibration waveform may be calculated from the vibration amplitude W and the ratio of each section.

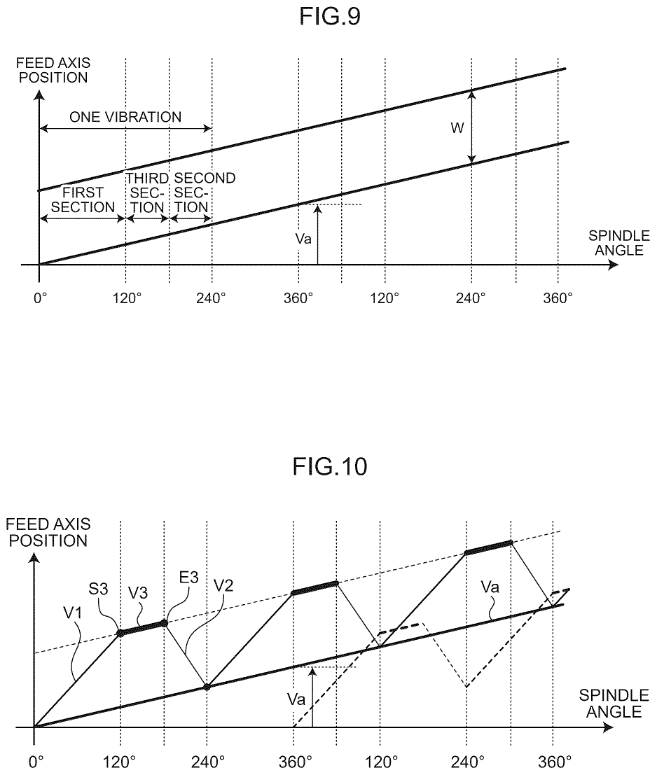

Thus, next, a procedure of calculating a vibration waveform on the basis of the vibration amplitude W and the ratio of each section will be described taking an example where the number of vibrations N is 1.5. Consider, for example, a case where a ratio of the first section: the third section: the second section=0.5:0.25:0.25 is given, and the feed axis travel speed Va during non-vibration machining and the vibration amplitude W are given. FIG. 9 is an explanatory diagram of another method of determining a vibration waveform with the third section in the numerical control device of the first embodiment. FIG. 10 is an explanatory diagram of another method of determining a vibration waveform with the third section in the numerical control device of the first embodiment. As illustrated in FIG. 9, assume that the ratio of each section, the first section: the third section: the second section=0.5:0.25:0.25, the feed axis travel speed Va during non-vibration machining, and the vibration amplitude W are given.

Since the number of vibrations N is 1.5, the spindle rotation angle per vibration is 240 degrees. The spindle rotation angle per vibration is divided in accordance with the ratio of each section to thereby determine the length (spindle angle) of each section.

When, for example, the third speed V3 is set to the same speed as the feed axis travel speed Va during non-vibration machining, the starting point S3 and the end point E3 of the third section are determined as illustrated in FIG. 10, so that the first speed V1 is determined by a value obtained by dividing the distance to the starting point S3 of the third section by the length (spindle angle) of the first section. Similarly, the second speed can also be calculated. It should be noted that the end point E2 of the second section is at the position where the spindle angle has advanced 240 degrees at the normal feed rate without the application of vibration.

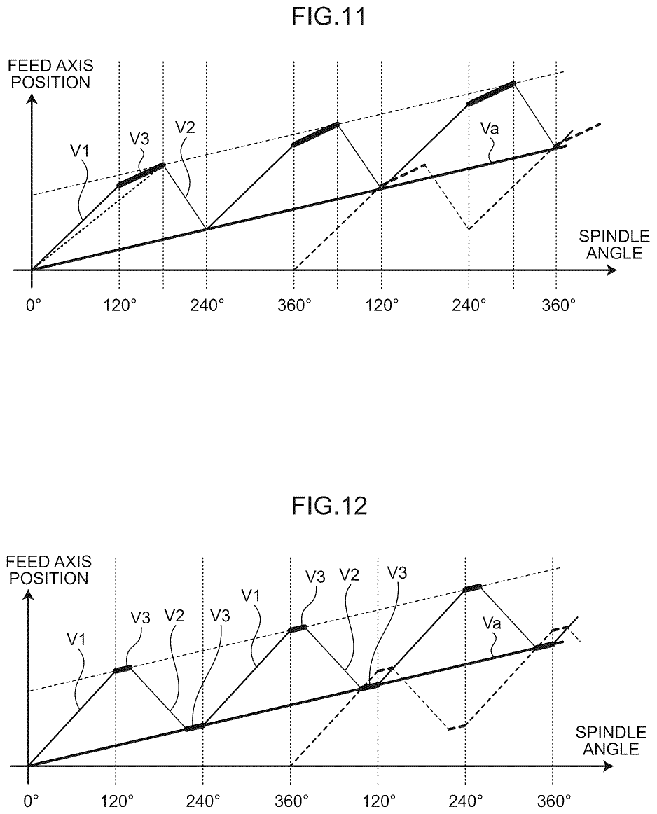

FIG. 11 is an explanatory diagram of another method of determining a vibration waveform with the third section in the numerical control device of the first embodiment. In FIG. 11, the third speed V3 is set to a speed lower than the first speed V1 and different from the feed axis travel speed Va during non-vibration machining. The third speed V3 should be a speed lower than the first speed V1, in which case the first speed V1 is set to a speed in a higher range and the third speed V3 in a lower range than a speed calculated on the assumption that the first speed V1=the third speed V3, so that the waveform can be calculated.

The above description has been made with reference to an example in which the third section is provided only at the point of switching from the first speed V1 to the second speed V2, and an example in which the third section is provided only at a point in one vibration have been described. However, the present invention is not limited to this, and various other patterns can be adopted.

For example, the third section may also be provided at the point of switching from the second speed V2 to the first speed V1. FIG. 12 is an explanatory diagram of another method of determining a vibration waveform with the third section in the numerical control device of the first embodiment. In FIG. 12, the third section for the motion at the third speed V3 is provided at both the point of switching from the first speed V1 to the second speed V2 and the point of switching from the second speed V2 to the first speed V1.

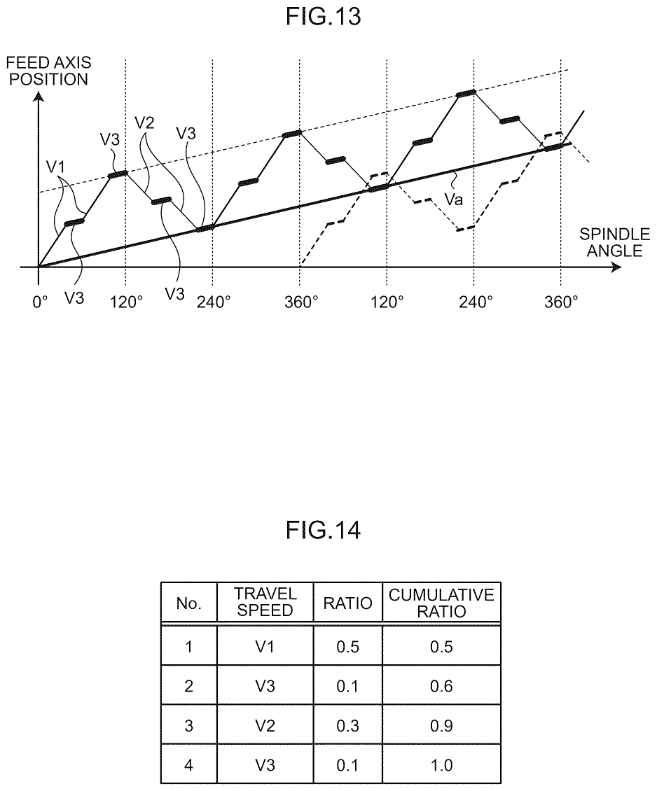

Further, the third section may be inserted in the middle of the first section and in the middle of the second section to divide the first section and the second section. FIG. 13 is an explanatory diagram of another method of determining a vibration waveform with the third section in the numerical control device of the first embodiment. In FIG. 13, the third section for the motion at the third speed V3 is provided in the middle of the first section, in the middle of the second section, at the point of switching from the first speed V1 to the second speed V2, and at the point of switching from the second speed V2 to the first speed V1.

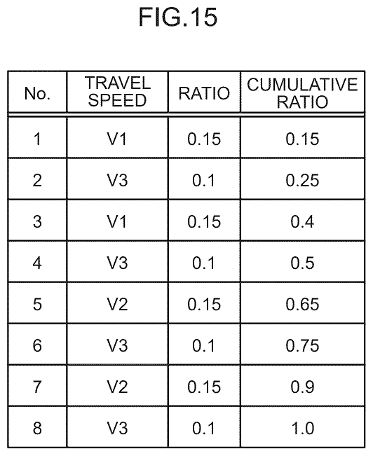

Calculation for obtaining such a vibration waveform may use a data table in which sets of the ratios and speeds of the individual sections are stored in order as illustrated in FIGS. 14 and 15. FIG. 14 is a diagram illustrating an example of the data table used to create the vibration waveform with the third section in the numerical control device of the first embodiment. FIG. 15 is a diagram illustrating another example of the data table used to create the vibration waveform with the third section in the numerical control device of the first embodiment. In the data table of FIG. 14, the third section for the motion at the third speed V3 is provided at the point of switching from the first section for the motion at the first speed V1 to the second section for the motion at the second speed V2, and at the point of switching from the second section to the first section. In the data table of FIG. 15, the third section for the motion at the third speed V3 is provided in the middle of the first section, in the middle of the second section, at the point of switching from the first speed V1 to the second speed V2, and at the point of switching from the second speed V2 to the first speed V1.

As described above, the numerical control device according to the first embodiment provides the third section for machining at the third speed V3, which is a speed lower than the first speed V1, and thus can reduce machining problems caused by high feed rates. For example, the cutting force and cutting heat generated during machining are reduced, so that the effect of extending the life of the tool and the improvement of the machined surface quality can be expected.

Further, the numerical control device according to the first embodiment reduces the cutting force in areas to be machined at the third speed V3 as compared with areas to be machined at the first speed V1, and thus can reduce the amount of elastic deformation produced in the workpiece or the like, achieving the effect of facilitating the breaking of chips. That is, when the cutting force during the forward motion increases, the amount of elastic deformation increases if the rigidity of the workpiece itself or a tool support structure including the machine, the tool, the tool rest, etc. is low. The effect of chip breaking in vibration cutting is achieved by a tool intermittently machining a workpiece with air-cutting therebetween during a reciprocating motion that allows the tool to pass again through a workpiece portion machined one spindle revolution before. If the amount of elastic deformation increases, the relative distance between the workpiece and the tool increases, so that the amount of cutting decreases. This results in a problem of failure to achieve the chip breaking effect as a workpiece portion that should have been machined one spindle revolution before is not machined and air-cutting does not occur between the workpiece and the tool even under conditions that should theoretically allow an air-cutting motion. However, the numerical control device according to the first embodiment can solve this problem.

Furthermore, the numerical control device according to the first embodiment can prevent a rapid speed change and reduce acceleration at the time of reversal by providing the third section for machining at the third speed V3 in a switching section between the first speed V1 and the second speed V2. This can reduce various problems caused by vibration due to acceleration. That is, when the third section is not provided, the forward motion and the backward motion are instantaneously switched, so that a large acceleration is produced during a reverse motion in the feed axis performing the operation of vibration cutting. The acceleration produced in the feed axis excites relative vibration between the workpiece and the tool, thereby not only degrading the machined surface quality but also serving as a vibration source that applies vibration to the entire machine, which causes problems such as mechanical resonance and vibration of the mechanical structure. The numerical control device according to the first embodiment can be expected to provide effects such as preventing degradation of the machined surface quality due to the vibration of the tool, and preventing wear of fastening components and the like due to the vibration of the machine.

The speed may change smoothly at a switching portion in each speed section. The speed change can be smoothed by a method, for example, providing the vibration command generation unit 11 with a smoothing filter such as a moving average filter immediately before the output of the feed command including vibration. This can be expected to provide the effects of further reducing acceleration caused by changes between the speeds, and further reducing vibration.

As a modification, a plurality of sine waves that are different from each other in one or more of phase, frequency, and amplitude may be superimposed to generate a waveform equivalent to the waveforms described above. Using sine waves as bases can provide a smoother travel waveform.

### Second Embodiment

A second embodiment describes in more detail the method of determining the individual section ratios performed by the individual section ratio determination unit 15. The configuration of the numerical control device 1 in the second embodiment is the same as that of the numerical control device 1 illustrated in FIG. 1, and redundant description thereof will be omitted.

The following three methods of determining the individual section ratios will be described:
(1) a method using input by the machining program 16,
(2) a method using load information on the feed unit 2 or the rotating unit 3, and
(3) a method using predetermined parameters

Other methods may be used, or two or more of the methods (1) to (3) may be combined.

(1) A method using input by the machining program 16 will be described. The individual section ratio determination unit 15 determines the individual section ratios on the basis of a character string and numerical values described in the machining program 16. For example, in the case of an EIA/ISO program, a combination of a character string and numerical values like “L0.5 M0.25 NO.25 ” may specify that the first section: the second section: the third section=0.5:0.25:0.25.

(2) A method using load information on the feed unit 2 or the rotating unit 3 will be described. In an embodiment of this method, the numerical control device 1 includes the load information acquisition unit 14 as illustrated in FIG. 1. The load information acquisition unit 14 acquires load information indicating loads from the feed unit 2 and the rotating unit 3, as needed. For example, in the case where a servomotor and a servo amplifier are used as the feed unit 2, the servomotor produces torque to enable a desired motion while resisting the load caused by machining. As the load increases, the opposing torque also increases. Consequently, a large current passes in proportion to the torque. As a result, the load information acquisition unit 14 acquires the load information that is, for example, feedback information on this current. Other than that, the load information may be the feedback value of the torque or an actual load value acquired by a pressure gauge such as an acceleration sensor or a load cell attached to the servomotor.

In the case where a spindle motor and a spindle amplifier are used as the rotating unit 3, torque is produced to maintain the relative rotational speed between the tool and the workpiece. When the tool and the workpiece come into contact with each other during machining, a load acts in the direction that reduces the rotational speed, and torque is produced against the load. As in the case of the servomotor described above, therefore, the current feedback value and the torque feedback value can be acquired to thereby obtain the load information.

Next, a method of determining the individual section ratios on the basis of the load information will be described. When set values such as the individual section ratios included in the information specifying the shape of the vibration waveform are appropriate in view of the machining conditions and the rigidity of the tool, the workpiece, and the machine structure, an air-cutting motion occurs with the workpiece and the tool separated, which results in chip breaking. During the air-cutting motion, the workpiece and the tool are separated, so that the loads applied to the workpiece and the tool are reduced. Consequently, during the air-cutting motion, the loads generated on the feed unit 2 and the rotating unit 3 are also reduced. On the contrary, when a machining load is so large as to cause elastic deformation and produce no air-cutting motion, the machining continues at all times, which results in no reduction of the loads. In view of this, monitoring the load information makes it possible to determine whether chip breaking is normally occurring.

The individual section ratio determination unit 15 that has acquired the load information from the load information acquisition unit 14 determines whether chip breaking occurs or not, on the basis of the load information. When the individual section ratio determination unit 15 determines that chip breaking does not occur, the individual section ratio determination unit 15 increases the ratio of the section for travel at the third speed. This reduces the machining load and increases the probability that chip breaking will occur. As to how much the ratio of the third section should be increased, the amount of change may be determined in advance using a parameter or the like, or may be determined in proportion to the magnitude of the load information. If changing the ratio of the third section does not result in a reduction in load, the ratio of the third section may be further increased, which may be repeated until a reduction in load occurs.

Alternatively, to reduce the elastic deformation, the first section may be divided and the third section may be added between the divided first sections, without changing the ratio of each section itself. A section in which machining is performed at the third speed lower than the first speed can be expected to provide the effect of relatively reducing the elastic deformation. Thus, rather than providing the first section in one place, dividing the first section and providing the third section therebetween can be expected to provide the effect of reducing the amount of elastic deformation even at the same ratio, resulting in chip breaking.

A description will be made as to another example of the section ratio determination method in a case where the load exceeds a certain threshold value. For example, if the first speed is too high, the load is so high that the tool may be damaged or the machined surface quality of the machined workpiece may be degraded. In view of this, when the load exceeds a certain threshold value, the individual section ratios may be adjusted to lower the first speed. For example, a method of increasing the ratio of the first section is possible.

(3) A method using predetermined parameters will be described. The individual section ratio determination unit 15 determines the individual section ratios with predetermined parameters. A plurality of ratio set values may be set, and the ratios to be used may be changed according to various threshold values. Examples of the threshold values include the feed rate, the number of spindle revolutions, the vibration frequency, the number of vibrations, and the vibration amplitude. In addition, combinations of various conditions and threshold values may be prepared in the form of a table or a matrix for selection.

The individual section ratios are determined with each of the above methods. The vibration command generation unit 11 generates the vibration waveform on the basis of the ratios. A method of generating the vibration waveform and the subsequent operation are the same as those in the first embodiment described above, and thus the description thereof is omitted here.

As described above, the second embodiment enables adjustment of the individual section ratios in accordance with the conditions. This makes it possible to perform vibration cutting with the vibration waveform according to the machining conditions, and properly adjust the load during machining and the produced acceleration as well. Further, by changing the individual section ratios on the basis of information on the load generated on the tool or the workpiece, the individual speeds and the individual section ratios can be automatically adjusted properly at all times, ensuring chip breaking.

### Third Embodiment

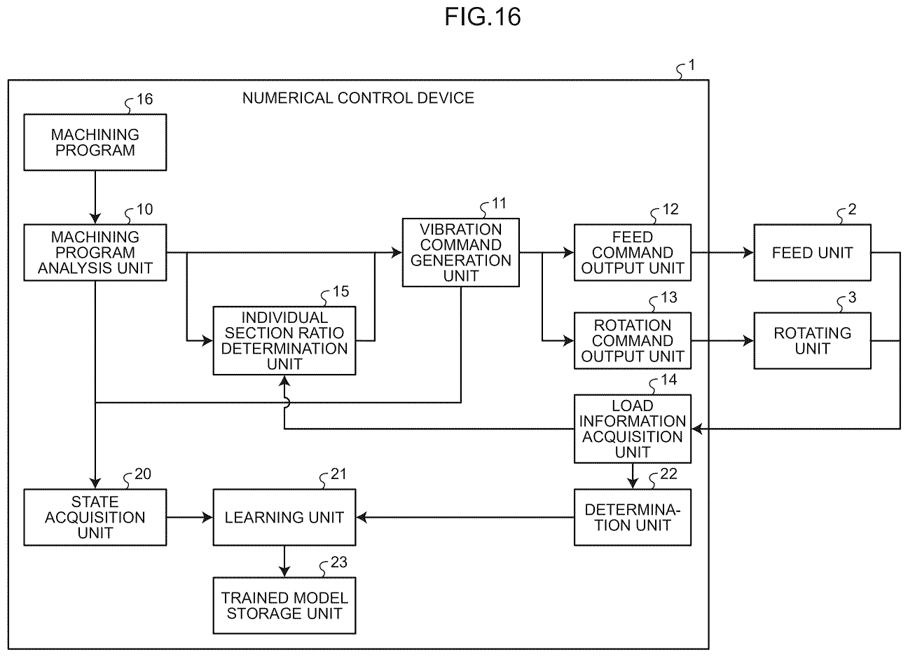

A third embodiment describes an example using machine learning. Matters unique to the third embodiment will be mainly described herein, and description of the following items similar to those in the first and second embodiments described above will be omitted. FIG. 16 is a block diagram illustrating a learning-time configuration of a numerical control device according to the third embodiment.

In FIG. 16, during machining by vibration cutting, a state acquisition unit 20 acquires state variables as input values for machine learning. The state variables may include data representing machining conditions, data representing vibration conditions, data representing feed motion details, and data representing the respective ratios of the first section, the second section, and the third section in one vibration, that is, the individual section ratios. The data representing the machining conditions includes, for example, the motion command information described above, and is acquired from the machining program analysis unit 10. The data representing the vibration conditions includes, for example, the information specifying the shape of the vibration waveform described above, and is acquired from the vibration command generation unit 11. The data representing the feed motion details includes, for example, the feed command described above and is acquired from the vibration command generation unit 11. The data representing the individual section ratios is acquired from the vibration command generation unit 11.

A determination unit 22 determines the quality of machining by vibration cutting, on the basis of the load information acquired from the load information acquisition unit 14. The determination result is output to a learning unit 21 as machining quality determination data. A quality determination method may simply determine whether air-cutting occurs or not from the load information, or involve providing a determination criterion that is a situation where the load exceeds a certain threshold value. The determination may be made using load statistics for a certain period of time. For example, a large variation in load causes a frequent change in speed change, in which case, the machined surface quality is likely to be degraded. As a result, the machining quality may be determined to be negative.

The learning unit 21 learns a rule for determining the individual section ratios, in accordance with a training data set created on the basis of the combination of the state variables output from the state acquisition unit 20 and the machining quality determination data output from the determination unit 22. That is, the learning unit 21 generates a trained model to infer the optimal individual section ratios from the state variables and the machining quality determination data.

The relevance between the machining quality determination and the state variables will be described. As described above, the state variables include the data representing the machining conditions, the data representing the vibration conditions, the data representing the feed motion details, and the data representing the individual section ratios. For example, in the case where the feed rate, which is an example of the data representing the machining conditions, is high, the load associated with machining tends to increase even during non-vibration machining, and thus the load during vibration cutting may further increase. It is therefore said that the machining quality is more likely to be determined to be negative than when the feed rate is low.

In the case where the vibration amplitude, which is an example of the data representing the vibration conditions, is large, the air-cutting zone tends to increase. Thus, chip breaking occurs, and the machining quality is more likely to be determined to be positive.

In the feed command, which is an example of the data representing the feed motion details, differences in characteristics depending on an axis that reflecting a vibration command may affect the machining quality determination. For example, in the case where an axis moving in the direction of gravity vibrates, the amplitude is likely to be attenuated in a direction against gravity, so that chip breaking is less likely to occur. Likewise, in the case where an axis on which a structure with a large weight is placed vibrates, the amplitude is likely to be attenuated from the viewpoint of the mechanical structure, and thus chip breaking is less likely to occur. In either case, the machining quality is more likely to be determined to be negative.

The learning unit 21 learns the optimal rule for determining the individual section ratios from these tendencies of the combinations of the state variables and the machining quality determination data.

A learning algorithm used by the learning unit 21 can be a known algorithm such as supervised learning, unsupervised learning, or reinforcement learning. A description here will be made assuming that a neural network is applied by way of example.

For example, the learning unit 21 learns the optimal combination of the individual section ratios by so-called supervised learning, in accordance with a neural network model. Supervised learning is a technique of giving the numerical control device 1 a set of inputs and result (label) data to learn features in the training data and infer results from inputs.

The neural network is composed of an input layer defined by a plurality of neurons, an intermediate layer (hidden layer) defined by a plurality of neurons, and an output layer defined by a plurality of neurons. The intermediate layer may be one of two or more intermediate layers.

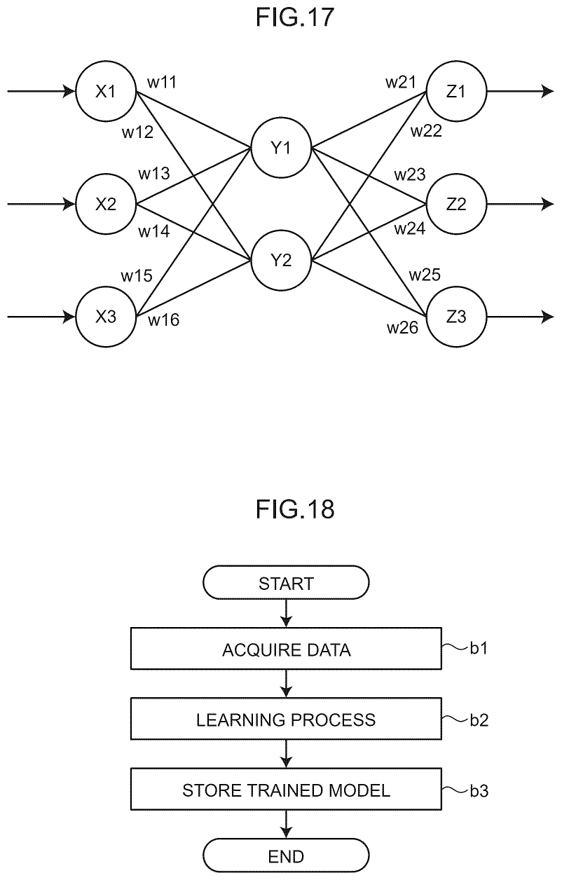

FIG. 17 is a diagram illustrating an exemplary configuration of the neural network used in the numerical control device of the third embodiment. For example, in a three-layer neural network as illustrated in FIG. 17, when a plurality of inputs are input to an input layer (X1 to X3), the values are multiplied by weights W1 (w11 to w16) and input to an intermediate layer (Y1 and Y2), and the results are further multiplied by weights W2 (w21 to w26) and output from an output layer (Z1 to Z3). The output results vary depending on the values of the weights W1 and the weights W2.

In the third embodiment, the neural network learns the optimal individual section ratios by so-called supervised learning, in accordance with training data created on the basis of the combination of the state variables acquired by the state acquisition unit 20 and the machining quality determination data output from the determination unit 22. That is, the neural network performs learning by inputting the state variables to the input layer and adjusting the weights W1 and the weights W2 so that the results output from the output layer approach the machining quality determination data. The learning unit 21 generates a trained model by performing learning as described above and outputs the trained model.

A trained model storage unit 23 stores the trained model output from the learning unit 21.

Next, a learning process in the numerical control device 1 will be described with reference to FIG. 18. FIG. 18 is a flowchart of a learning process in the numerical control device 1 of the third embodiment. In step bl, the state acquisition unit 20 acquires the state variables, and the determination unit 22 acquires the load information, determines the machining quality, and outputs the machining quality determination data. Although the state variables and the machining quality determination data are defined as being simultaneously acquired and output, the state variables and the machining quality determination data have only to be input in association with each other, and thus the state variables and the machining quality determination data may be acquired and output at different timings. In step b2, the learning unit 21 learns the optimal individual section ratios by so-called supervised learning, in accordance with training data created on the basis of the combination of the state variables acquired by the state acquisition unit 20 and the machining quality determination data output from the determination unit 22, and generates a trained model. In step b3, the trained model storage unit 23 stores the trained model generated by the learning unit 21.

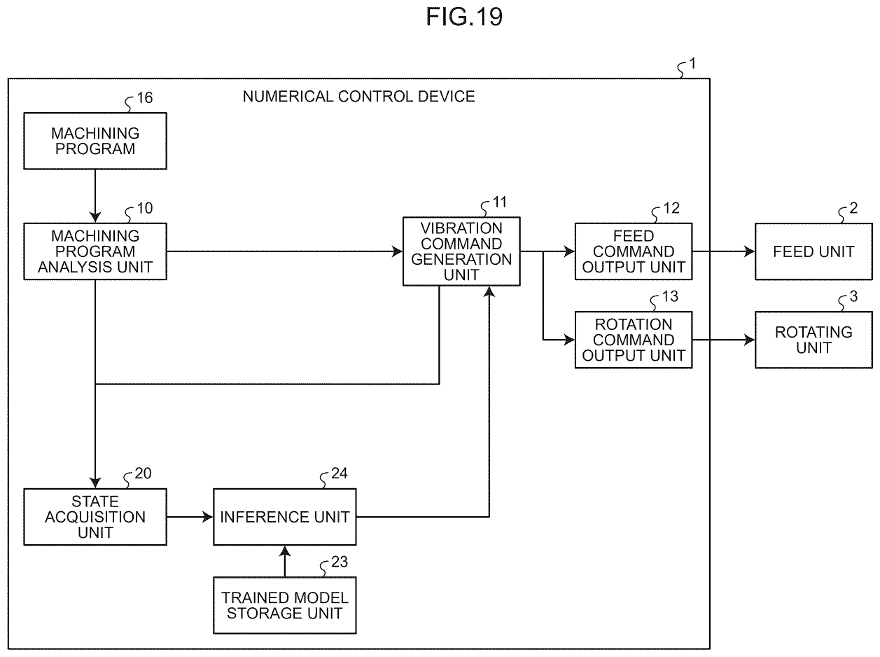

FIG. 19 is a block diagram illustrating a reference-time configuration of the numerical control device according to the third embodiment. An inference unit 24 infers the optimal individual section ratios obtained using the trained model stored in the trained model storage unit 23. That is, inputting, to the trained model, the state variables acquired by the state acquisition unit 20 makes it possible to output the optimal individual section ratios inferred from the state Variables. The inference unit 24 has been described as outputting the optimal individual section ratios using the trained model trained by the state acquisition unit 20 of the numerical control device 1. Alternatively, a trained model may be acquired from the outside such as another numerical control device, and the optimal individual section ratios may be output on the basis of this trained model.

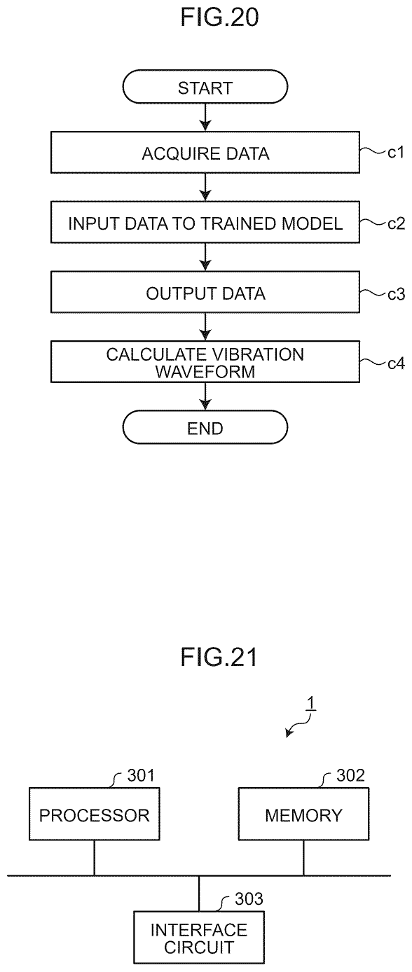

Next, a process to obtain the optimal individual section ratios using the trained model will be described with reference to FIG. 20. FIG. 20 is a flowchart of an inference process in the numerical control device 1 of the third embodiment. In step c1, the state acquisition unit 20 acquires the state variables. In step c2, the inference unit 24 inputs the state variables to the trained model stored in the trained model storage unit 23 to obtain the optimal individual section ratios. In step c3, the inference unit 24 outputs the optimal individual section ratios obtained by the trained model to the numerical control device 1. In step c4, the numerical control device 1 calculates the vibration waveform, using the output optimal individual section ratios. This can optimally adjust the conditions of machining using vibration cutting.

The present embodiment has described supervised learning applied to the learning algorithm used by the learning unit 21, but the present invention is not limited to this. Other than supervised learning, reinforcement learning, unsupervised learning, semi-supervised learning, or the like may be applied to the learning algorithm. Further, deep learning to learn extraction of features themselves may be used, and machine learning may be performed according to another known method such as genetic programming, functional logic programming, or a support vector machine.

Thus, the third embodiment can determine the optimal individual section ratios in accordance with the conditions of machining by vibration cutting. Since learning is performed during actual machining, a method for accurate determination of the individual section ratios is learned. In addition, since the trained model trained during actual machining is used, accurate inference is possible. In turning, for example, gradual cutting is performed a plurality of times to obtain a desired shape. For example, machining is divided into rough machining, semi-finish machining, and finish machining. Consequently, machining is performed repeatedly along a similar machining path, and thus it is also possible to optimize the individual section ratios as machining proceeds.

A hardware configuration of the numerical control device 1 will be described. FIG. 21 is a diagram illustrating an exemplary hardware configuration of the numerical control device 1 according to the first to third embodiments. The numerical control device 1 can be implemented by a processor 301, memory 302, and an interface circuit 303 illustrated in FIG. 21. An example of the processor 301 is a central processing unit (CPU, also called a central processor, a processing device, an arithmetic device, a microprocessor, a microcomputer, a processor, or a digital signal processor (DSP) ), or a system large-scale integration (LSI). Examples of the memory 302 are random-access memory (RAM) and read-only memory (ROM).

The numerical control device 1 is implemented by the processor 301 reading and executing a program for performing the operation of the numerical control device 1 stored in the memory 302. The program can be said to cause a computer to perform the procedure or method in the numerical control device 1. The memory 302 is also used as temporary memory when the processor 301 executes various kinds of processing. The functions of the numerical control device 1 may be implemented partly by dedicated hardware and partly by software or firmware.

The configurations described in the above embodiments illustrate an example of the subject matter of the present disclosure, and can be combined with another known art, and can be partly omitted or changed without departing from the scope of the present disclosure.

### REFERENCE SIGNS LIST

1 numerical control device; 2 feed unit; 3 rotating unit; 10 machining program analysis unit; 11 vibration command generation unit; 12 feed command output unit; 13 rotation command output unit; 14 load information acquisition unit; 15 individual section ratio determination unit; 16 machining program; 20 state acquisition unit; 21 learning unit; 22 determination unit; 23 trained model storage unit; 24 inference unit; E1, E2, E3 end point; G air-cutting zone; N number of vibrations; S1, S2, S3 starting point; V1 first speed; V2 second speed; V3 third speed; Va feed axis travel speed during non-vibration machining; W vibration amplitude; x margin.

1-7. (canceled)

8. A numerical control device comprising:
rotation command output circuitry to output a rotation command to relatively rotate a workpiece and a tool; and
feed command output circuitry to output a feed command to relatively move the workpiece and the tool,
the feed command being able to include a vibration motion command to alternately repeat a forward motion and a backward motion,
the vibration motion command including, in one vibration,
a first section for travel at a first speed that is a travel speed during the forward motion,
a second section for travel at a second speed that is a travel speed during the backward motion, and
a third section for travel at a third speed that is a travel speed during the forward motion and is a speed lower than the first speed, wherein
the numerical control device comprises an individual section ratio determination circuitry to determine ratios of the first section, the second section, and the third section in one vibration in the vibration motion command, and
the section ratio determination circuitry determines the ratios of the first section, the second section, and the third section, in accordance with a combination of a character string and numerical values specifying the ratios of the individual sections and described in a machining program.

9. A numerical control device comprising:
rotation command output circuitry to output a rotation command to relatively rotate a workpiece and a tool; and
feed command output circuitry to output a feed command to relatively move the workpiece and the tool,
the feed command being able to include a vibration motion command to alternately repeat a forward motion and a backward motion,
the vibration motion command including, in one vibration,
a first section for travel at a first speed that is a travel speed during the forward motion,
a second section for travel at a second speed that is a travel speed during the backward motion, and
a third section for travel at a third speed that is a travel speed during the forward motion and is a speed lower than the first speed, wherein the numerical control device further comprises
individual section ratio determination circuitry to determine ratios of the first section, the second section, and the third section in one vibration in the vibration motion command, and
the section ratio determination circuitry determines the ratios of the first section, the second section, and the third section, on the basis of parameters representing the ratios of the first section, the second section, and the third section.

10. The numerical control device according to claim 9, wherein
the section ratio determination circuitry determines the ratios of the first section, the second section, and the third section, on the basis of a comparison between a threshold value and any one of a feed rate, the number of revolutions of a spindle, a vibration frequency, the number of vibrations, and a vibration amplitude.

11. A numerical control device comprising:
rotation command output circuitry to output a rotation command to relatively rotate a workpiece and a tool; and
feed command output circuitry to output a feed command to relatively move the workpiece and the tool,
the feed command being able to include a vibration motion command to alternately repeat a forward motion and a backward motion,
the vibration motion command including, in one vibration,
a first section for travel at a first speed that is a travel speed during the forward motion,
a second section for travel at a second speed that is a travel speed during the backward motion, and
a third section for travel at a third speed that is a travel speed during the forward motion and is a speed lower than the first speed, wherein
the numerical control device comprises an individual section ratio determination circuitry to determine ratios of the first section, the second section, and the third section in one vibration in the vibration motion command, and wherein
the individual section ratio determination circuitry determines the ratios of the first section, the second section, and the third section in one vibration in the vibration motion command, on the basis of load information indicating loads generated on the workpiece and the tool during a vibration motion.

12. The numerical control device according to claim 8, wherein
the third section is provided at least between the first section and the second section.

13. The numerical control device according to claim 9, wherein
the third section is provided at least between the first section and the second section.

14. The numerical control device according to claim 10, wherein
the third section is provided at least between the first section and the second section.

15. The numerical control device according to claim 11, wherein
the third section is provided at least between the first section and the second section.

16. The numerical control device according to claim 8, wherein
the third speed is the same speed as a relative travel speed between the workpiece and the tool during non-vibration machining.

17. The numerical control device according to claim 9, wherein
the third speed is the same speed as a relative travel speed between the workpiece and the tool during non-vibration machining.

18. The numerical control device according to claim 10, wherein
the third speed is the same speed as a relative travel speed between the workpiece and the tool during non-vibration machining.

19. The numerical control device according to claim 11, wherein
the third speed is the same speed as a relative travel speed between the workpiece and the tool during non-vibration machining.
